(19) United States
(12) Patent Application Publication
(10) Pub. No.: US 2001/0012761 A1
(43) Pub. Date: Aug. 9, 2001

(54) Portable radio communication apparatus having a call signal arrival indicating function and a response function without any trouble to circumstance

(76) Inventors: Masataka Mitama, Tokyo (JP); Tetsuya Takaki, Tokyo (JP)

Correspondence Address: McGinn & Gibb, PLLC, Suite 200, 8321 Old Courthouse Road, Vienna, VA, 22182-3817, US

(21) Appl. No.: 09/771,567

(22) Filed: Jan. 30, 2001

(30) Foreign Application Priority Data
Feb. 3, 2000 (JP) 025896/2000

(51) Int. Cl. H04B 1/40

(52) U.S. Cl. 455/41; 455/11.1; 455/66; 455/74

(57) ABSTRACT

A portable radio communication apparatus, includes a main body, and a sub-apparatus. The main body communicates with a partner. The sub-apparatus is mechanically separated from the main body. The main body and the sub-apparatus communicate with each other wirelessly. The sub-apparatus includes a call signal arrival display unit and a response unit. When the main body gets a call signal from the partner, the main body transmits a call arrival signal to the sub-apparatus. The main body transmits a response message to the partner in response to a response signal. The call signal arrival display unit sends a notice that the main body gets the call signal in response to the call arrival signal. The response unit outputs the response signal to the main body in response to an operation performed on the response unit.

### BACKGROUND OF THE INVENTION

1. Field of the Invention

The present invention relates to a portable radio communication apparatus. More particularly, the present invention relates to a portable radio communication apparatus such as a portable telephone and the like.

2. Description of the Related Art

In recent years, in a portable telephone that has widely spread due to its convenience and the like, a call can be made from any location if it belongs to a service range. On the other hand, a call arrival tone gives a trouble to adjacent strangers during a meeting, during taking a train, during listening to a lecture meeting, or during listening to a concert. For this reason, traditionally, a portable telephone has been known for reporting a call signal arrival to a user of a portable telephone by using a vibration of a vibrator.

However, the conventional portable telephone has the inconvenience that the user must always carry the portable telephone on the body, since the user need to feel the vibration of the vibrator, in order to report the call signal arrival by using the vibrator.

Even if the user can know the call signal arrival from the vibrator without any trouble to a circumstance, if the user responds to the call signal arrival by saying a word during a meeting, during taking a train or the like, this consequently gives a trouble to the circumstance.

Japanese Laid Open Patent Application (JP-A-Heisei, 8-149534) discloses the following portable information terminal. This has the configuration in which a portable information terminal body is separated from an external reporter. This identifies an attribute data added to an information received by the portable information terminal body, and outputs a report signal different for each kind of an information, to the external reporter by using an electric wave, an infrared ray or a supersonic wave, and changes an interval between on-off states of a reporter, such as an LED, a vibrator or the like in the external reporter, and a strength of an announcement or a vibration, in accordance with the report signal, and then reports the arrival of the information and the kind of the information to the user.

Japanese Laid Open Patent Application (JP-A-Heisei, 10-224440) discloses the following portable telephone. A display is detachably mounted in a portable telephone body. When the display is located away from the portable telephone body, an electric wave transmitted by a transmitter in the portable telephone body is received by a receiver in the display. Thus, an information is transmitted to thereby report a call signal arrival to a user. On the other hand, when the display is inserted into the portable telephone body, the transmission of the electric wave from the transmitter in the portable telephone body is stopped, and the information is sent to the display through a connection terminal by means of a wire, and the call signal arrival is reported to the user.

Japanese Patent Publication No.2737672 discloses the following portable information communication apparatus. This is the portable information communication apparatus in which each of a portable radio telephone and a portable operator sends and receives an information through an optical communication, and has the following features. That is, the portable radio telephone is provided with; a radio transmitter/receiver for wirelessly communicating with a base station of a radio telephone system or a radio data communication system; a voice receiver/output device for receiving and outputting a voice from and to the radio transmitter/receiver; a first operator for entering at least a dial information; a reporter for reporting at least a data arrival; a first light communicator for optically communicating with the portable operator; a first information memory for storing a data received from the radio transmitter/receiver, an information received by the first light communicator, and an information entered by the first operator; a data processor for processing the reception information from the first light communicator and outputting to the first information memory or the radio transmitter/receiver; and a first controller for executing a control of the first information memory or the reporter in accordance with the input information from the first operator or the reception signal from the radio transmitter/receiver, a control to generate a predetermined code and send through the radio transmitter, a periodic monitor of an accumulation information in the first information memory, and a control of the data process in accordance with the accumulation information, respectively. The portable operator is composed of: a second operator for entering at least one of the dial information and the transmission data; a display for displaying the information; a second light communicator for optically communicating with the first light communicator; a second information memory for accumulating the information entered by the second operator or the reception data of the second light communicator; and a second controller for executing a control of the second information memory or the display in accordance with the input information from the second operator or the reception signal from the second light communicator, and a control to output the accumulation information in the second information memory to the second light communicator.

Japanese Patent Publication No.2839016 discloses the following PHS terminal with a data transfer control remote controller. In the PHS terminal with the data transfer control remote controller that is provided with a PHS body in PHS (Personal Handyphone System) and a remote controller which is physically independent from the PHS body and can remotely control the PHS body by using a radio transmission and also has a function of carrying out a ringer singing action through a voice or a vibration, it is provided with: an antenna to transfer a radio data between it and the PHS body; a transmitter/receiver for transmitting and receiving the data to and from the PHS body; a memory for storing a transmission number transferred by the PHS body; a memory for storing a command group to be transferred to the PHS body; a display for displaying the transmission number that is transferred by the PHS body and stored in the memory; a ringing mode switcher having an input key for switching a mode as to whether or not a ringing of the remote controller is done; a ringing stopper having an input key for stopping the ringing of the remote controller; a ringing mode switch key for setting a command to switch a mode as to whether or not a ringing for the PHS body is done; a ringing stop key for setting a command to stop the ringing for the PHS body; a remote off hook key for setting a command of a calling indicator for the PHS body; a response message on/off switch key for setting a command to turn on and off a response message for the PHS body; a response message mode switch key for setting a command to select a mode from a plurality of response functions of the PHS body; a command execution key for setting the various keys, sending out the command group stored in the memory to the PHS body, and instructing it to execute the command; a bell for providing a ringer as an acoustic tone; and a vibration generator for generating the ringer as the vibration.

Japanese Patent Publication No.2865135 discloses the following radio communication apparatus. This is the radio communication apparatus constituted by a separable car mount portion and a portable terminal portion. The car mount portion is provided with: a first CPU that can identify between a voice and a data; a first transmitter/receiver for carrying out a transmission or a reception to and from another station; a second transmitter/receiver for carrying out a transmission or a reception to and from the portable terminal portion; and a first controller for controlling them. The portable radio portion is provided with a second CPU, a third transmitter/receiver for carrying out a transmission or a reception to and from the car mount portion, and a second controller them. If there is a call signal arrival to the car mount portion from another station, the first CPU judges whether or not the car mount portion and the portable terminal portion are separated from each other. If they are judged to be not separated, the call signal arrival is treated as a normal call signal arrival. If they are judged to be separated, the first CPU judges whether the communication from another station is done through a voice or a data. In a case of the voice, a number of a partner station and a call signal arrival message are transmitted through the third transmitter/receiver. In a case of the data, a number of a partner station and a data message are transmitted through the third transmitter/receiver. The portable terminal portion receiving the call signal arrival message or the data message at the third transmitter/receiver can carry out a transmission since the second CPU displays its content on a display and the partner number is entered.

### SUMMARY OF THE INVENTION

The present invention is accomplished in view of the above mentioned problems. Therefore, an object of the present invention is to provide a portable radio communication apparatus having a call signal arrival indicating function and a response function without any trouble to a circumstance. Another object of the present invention is to provide a portable radio communication apparatus which can report a call signal arrival even if a user does not always carry it on the body.

In order to achieve an aspect of the present invention, a portable radio communication apparatus, includes: a main body communicating with a partner; and a sub-apparatus mechanically separated from the main body, wherein the main body and the sub-apparatus communicate with each other wirelessly, and the sub-apparatus includes a call signal arrival display unit and a response unit, and wherein when the main body gets a call signal from the partner, the main body transmits a call arrival signal to the sub-apparatus, and the main body transmits a response message to the partner in response to a response signal, and wherein the call signal arrival display unit sends a notice that the main body gets the call signal in response to the call arrival signal, and the response unit outputs the response signal to the main body in response to an operation performed on the response unit.

In this case, the main body and the sub-apparatus communicate with each other wirelessly with the Bluetooth standard.

Also in this case, the main body and the sub-apparatus communicate with each other wirelessly with the PIAFS (PHS Internet Access Forum Standard).

Further in this case, the sub-apparatus is a tabletop unit.

In this case, the sub-apparatus is a card-type unit.

Also in this case, the sub-apparatus further includes a switch, and wherein when the switch is one of on and off, the call signal arrival display unit sends the notice and the response unit outputs the response signal to the main body, and wherein when the switch is the other of on and off, the call signal arrival display unit does not send the notice and the response unit does not output the response signal to the main body and the main body performs one of ringing and vibration when the main body gets the call signal from the partner.

Further in this case, the main body transmits a preset response message to the partner as the response message.

In this case, the sub-apparatus further includes a partner display unit displaying an identifier indicating the partner based on the call arrival signal.

Also in this case, when the main body gets the call signal from the partner, both the main body and the sub-apparatus do not ring and do not vibrate.

Further in this case, the call signal arrival display unit sends the notice by one of a light emission and a flashing indication without using a ringing and a vibration.

In this case, the sub-apparatus further includes a response message display unit to display one of the response message and an identifier indicating the response message.

Also in this case, the response message display unit displays one of a plurality of preliminarily prepared response messages selectively as the response message.

Further in this case, the main body has a receiver unit and a transmitter unit and an operator used in a dial and a display unit displaying an information such as a dial and an antenna.

In this case, the main body further includes a switch, and wherein when the switch is one of on and off, the call signal arrival display unit sends the notice and the response unit outputs the response signal to the main body, and wherein when the switch is the other of on and off, the call signal arrival display unit does not send the notice and the response unit does not output the response signal to the main body and the main body performs one of ringing and vibration when the main body gets the call signal from the partner.

Also in this case, the operation is performed on the response unit by a user of the portable radio communication apparatus in response to the notice.

Further in this case, the response message indicates that a user of the portable radio communication apparatus can not answer the call signal.

In this case, the main body performs a disconnection process on the call signal after transmitting the response message.

Also in this case, the response message is stored in the main body.

Further in this case, the plurality of preliminarily prepared response messages indicate at least one of contents that a user of the portable radio communication apparatus is in a meeting, and that the user is in a car or train, and that the user will call the partner later.

Also in this case, the one of the plurality of preliminarily prepared response messages is selected by a user of the portable radio communication apparatus.

### BRIEF DESCRIPTION OF THE DRAWINGS

FIG. 1 is a block diagram showing an embodiment of the present invention;

FIG. 2 is a flowchart describing an operation of FIG. 1;

FIG. 3A is a view showing one example of a display panel surface of a sub-apparatus of FIG. 1; and

FIG. 3B is a view showing one example of another display panel surface of the sub-apparatus of FIG. 1.

### DESCRIPTION OF THE PREFERRED EMBODIMENTS

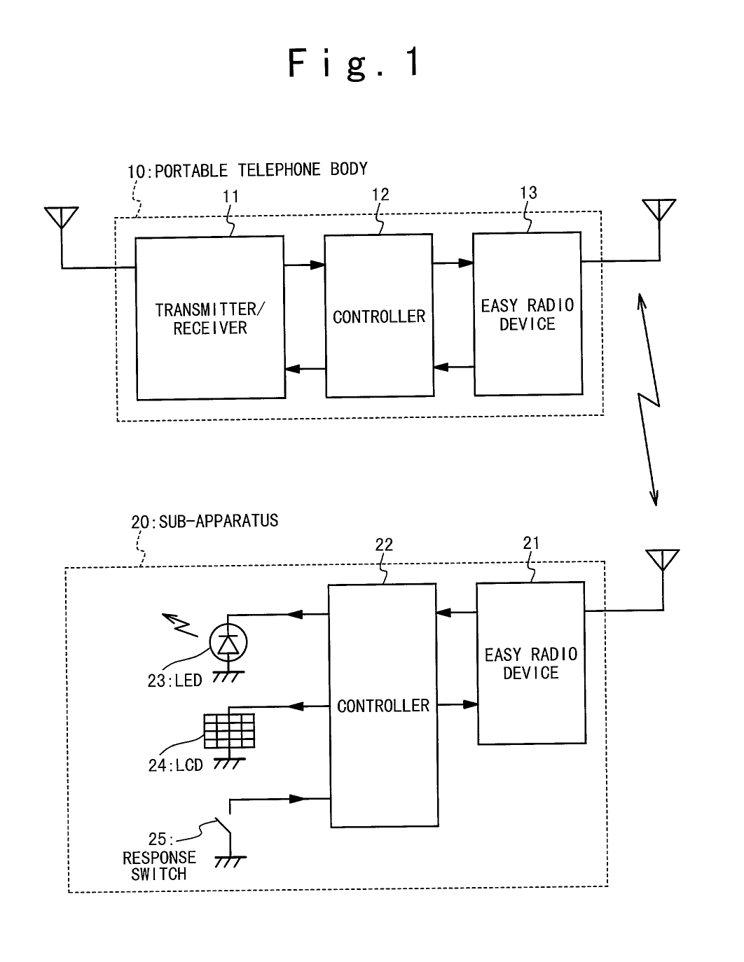

An embodiment of the present invention will be described below with reference to the attached drawings. FIG. 1 shows a block diagram of an embodiment of a portable radio communication apparatus according to the present invention. This portable radio communication apparatus in the embodiment is provided with a portable telephone body 10 and a sub-apparatus 20, in an example of a portable telephone. The portable telephone body 10 has a transmitter/receiver 11 for communicating with a partner terminal through a radio base station (not shown), a controller 12 and an easy radio device 13 for wirelessly communicating with the sub-apparatus 20.

Also, the sub-apparatus 20 is a portable call signal arrival display and response apparatus, such as a desk top type, a card type, or the like. It is provided with: an easy radio device 21 for wirelessly communicating with the portable telephone body 10; a controller 22; a light emission diode (LED) 23 for indicating a call signal arrival while emitting a light; a liquid crystal display (LCD) 24 for carrying out various indications; and a response switch 25 to be used at a time of a response. The portable telephone body 10 has components originally necessary for a telephone, such as a receiver unit and a transmitter unit and an operator used in a dial and a display section displaying an information such as a dial and an antenna and the like, although they are not shown.

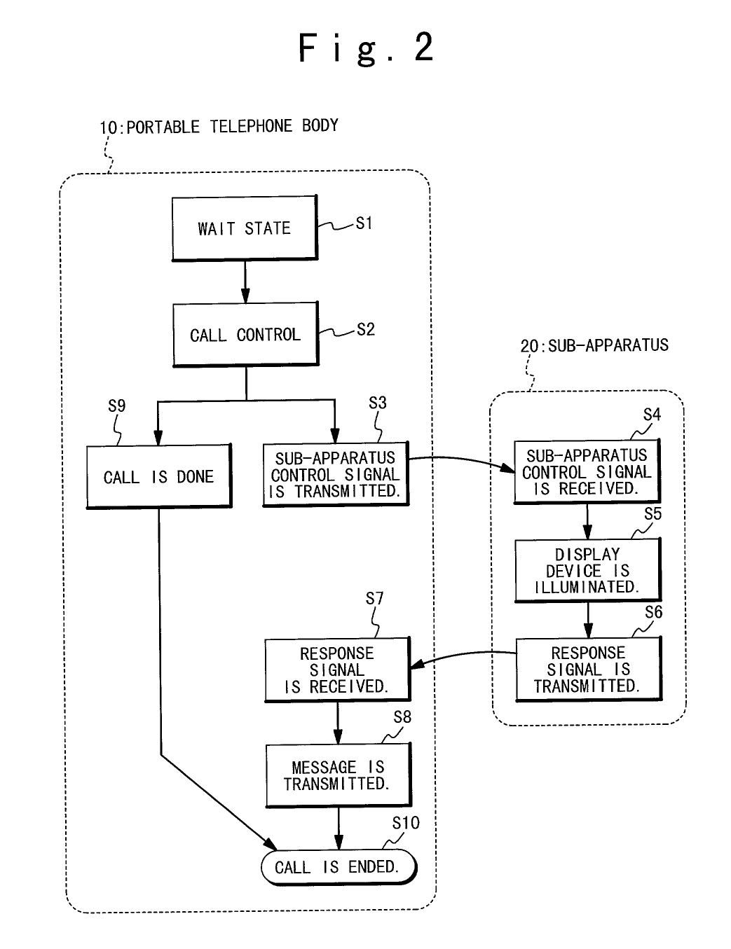

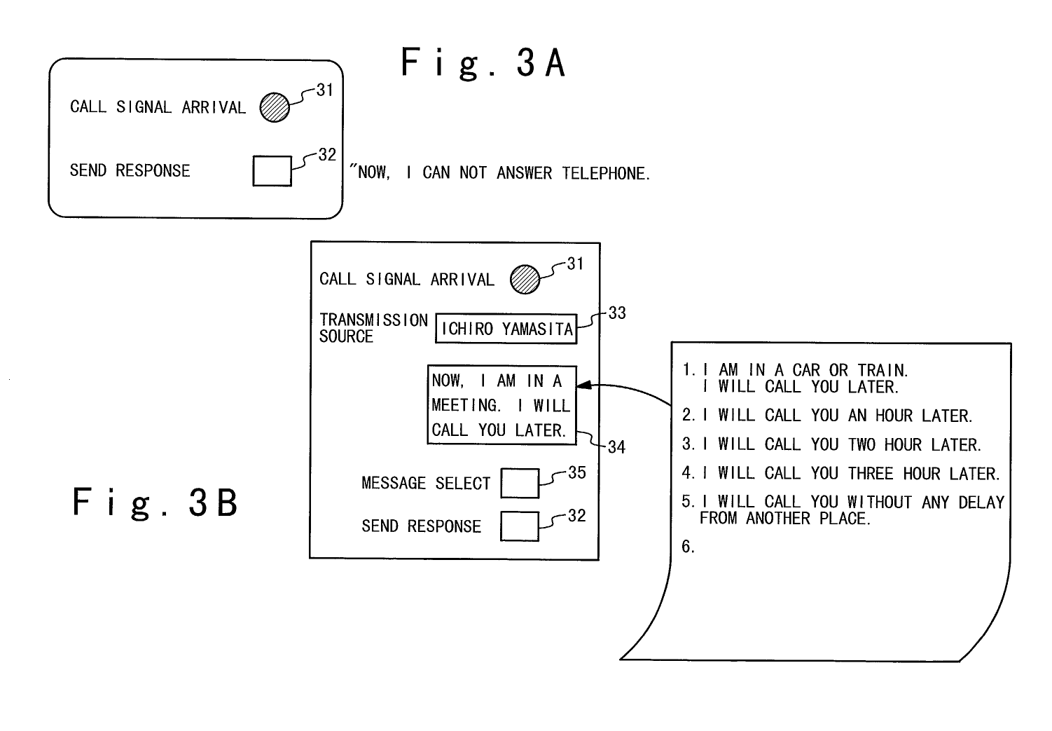

The operation of the embodiment in FIG. 1 will be described below by using a flowchart in FIG. 2 together with the views showing examples of displays of FIGS. 3A and 3B. When the portable telephone body 10 is at a wait state (Step S1), if it receives a call signal (Step S2), a call arrival signal is sent through the transmitter/receiver 11 to the controller 12. At this time, if a call arrival tone gives a trouble to a circumstance, since a sub-apparatus operation switch (although its illustration is omitted, it is usually mounted in the sub-apparatus 20) is set on by a user, the controller 12 generates a display device illumination signal, on the basis of the input of the call arrival signal, in this case, and further sends the signal to the easy radio device 13 together with a caller information, as necessary. Accordingly, it is wirelessly transmitted as a sub-apparatus control signal to the sub-apparatus 20 (Step S3). The sub-apparatus operation switch can be mounted in the portable telephone body 10.

The portable telephone body 10 and the sub-apparatus are located within a range where a radio communication can be done by using a weak electric wave. The easy radio device 21 in the sub-apparatus 20 receives a sub-apparatus control signal (including the caller information as necessary) wirelessly transmitted from the easy radio device 13 by using the weak electric wave (Step S4), and sends it to the controller 22. The controller 22 sends the display device illumination signal to the LED 23, in response to the reception of the sub-apparatus control signal, and illuminates it, and accordingly indicates the call signal arrival (Step S5).

A display panel surface of the sub-apparatus 20 has, for example, a call signal arrival display 31 constituted by the LED 23 and a button 32 of a response switch 25, as shown in FIG. 3A. The light emission of the LED 23 causes the call signal arrival display 31 to be illuminated, and thereby causes the call signal arrival to be indicated. Thus, the user responses by pushing down the button 32 (the response switch 25). Hence, a response signal is wirelessly transmitted through the controller 22 and the easy radio device 21 to the portable telephone body 10 by using the weak electric wave (Step S6).

When the easy radio device 13 in the portable telephone body 10 receives the response signal and sends to the controller 12 (Step S7), the controller 22 instructs the transmitter/receiver 11 to wirelessly transmit one preliminarily prepared message (for example, [Now, I Can Not Answer Telephone]) (Step S8). After that, the controller 22 automatically carries out a disconnection process, and the communication is ended (Step S10). Thus, according to this embodiment, the response to the call signal arrival can be done without any trouble to a stranger, even in a case of a call signal arrival at a position where a call arrival tone gives a trouble to an adjacent stranger, during a meeting, during taking a train or the like.

Also, the sub-apparatus 20 is designed so as to enable the radio communication with the portable telephone body 10 by using the weak electric wave. It is another apparatus mechanically separated from the portable telephone body 10, and the call signal arrival is displayed while it is illuminated. So, the user need not always carry it on the body, such as the vibrator. The user can be released from the inconvenience that the user always carries it on the body.

When the sub-apparatus operation switch is set off, a call arrival tone is ringed in the portable telephone body 10, similarly to the conventional technique, and a call to the caller is done through a procedure similar to that of the conventional technique (Step S9). A disconnecting operation is done in accordance with the end of the call, and the communication is ended (Step S10).

By the way, the number of response messages is only one in the configuration of the display panel surface of the sub-apparatus 20 shown in FIG. 3A. However, a plurality of response messages are prepared in the controller 12, in a case of the configuration of the display panel surface shown in FIG. 3B. In FIG. 3B, the same symbols are given to the same configuration parts as those of FIG. 3A, and their explanations are omitted. In FIG. 3B, a transmission source indicator 33 and a message indicator 34 are respectively constituted by the LCDs 24 of FIG. 1. Also, a message selection switch 35 is not shown in FIG. 1. However, it is mounted in the sub-apparatus 20.

A transmission source information received together with the call arrival signal from a radio basic station in the portable telephone body 10 is transmitted from the portable telephone body 10 to the sub-apparatus 20 by using the weak electric wave, and it is displayed in the transmission source indicator 33. Also, the message indicator 34 is designed so as to selectively indicate a plurality of preliminarily prepared messages or the identifiers of them and also indicate one message arbitrarily selected by the user using the message selection switch 35.

In this case, the plurality of preliminarily prepared messages includes the following contents. That is to say, the content that now, the user can not answer telephone and the content that now, the user is in a meeting, and so the user will call the partner later and the content that the user is in a car or train, and so the user will call the partner later and the content that the user call the partner an hour later and the content that the user will call the partner two hour later and the content that the user will call the partner three hour later and the content that the user will call the partner without any delay from another place are included.

When the sub-apparatus 20 has the display panel surface in FIG. 3B, if the user responds to the call signal arrival by pushing down the button 32 (response switch 25), the message selection signal together with the response signal is wirelessly transmitted through the controller 22 and the easy radio device 21 to the portable telephone body 10 by using the weak electric wave, and it is received by the easy radio device 13 in the portable telephone body 10, and sent to the controller 12. Then, the controller 12 instructs the transmitter/receiver 11 to wirelessly transmit one message selected in accordance with the message selection signal from a plurality of preliminarily prepared messages.

Thus, when the sub-apparatus 20 has the display panel surface in FIG. 3B, even if there is a call signal arrival at a position where a call arrival tone gives a trouble to an adjacent stranger, a response to the call signal arrival can be naturally carried out without any trouble to the stranger. Moreover, it is possible to transmit a message optimal for a current situation of the user. Thus, a further appropriate response to the call signal arrival can be provided for the transmission source.

By the way, the present invention is not limited to the above-mentioned embodiment. For example, the call signal arrival may be reported by a flashing indication. It is not always necessary that the sub-apparatus 20 is the desk top type or the card type. It may be designed that the user carries the sub-apparatus 20 on the body, as necessary, during taking a bus or a train. Moreover, the above-mentioned embodiment is applied to the portable telephone. However, the present invention may be similarly applied to a data communication apparatus and the like.

The present invention is accomplished in view of a two-way communication type of easy radio technique represented by Bluetooth or the PIAFS (PHS Internet Access Forum Standard) or like. It is designed such that a sub-apparatus can wirelessly communicate with a portable radio communication apparatus body by using a weak electric wave, and is another apparatus mechanically separated from the portable radio communication apparatus body, and a call signal arrival is displayed on the sub-apparatus. Thus, a user need not always carry it on the body, such as a vibrator. Also, the call signal arrival can be reported by using a method besides a call arrival tone and a vibration. A response to the call signal arrival can be attained by sending a response message in accordance with a response signal.

In the present invention, the sub-apparatus can be driven by using an operation switch only at a necessary time, and the portable radio communication apparatus body can be used in the same manner as the conventional technique.

In the present invention, a user can select one response message from a plurality of response messages, depending on the situation of the user.

As mentioned above, according to the present invention, the call signal arrival is indicated by using the sub-apparatus that is another apparatus mechanically separated from the portable radio communication apparatus body. So, the user need not always carry it on the body, such as the vibrator. Thus, the user can be released from the inconvenience that the user always carries it on the body. Also, according to the present invention, the call signal arrival can be reported by using the method besides the call arrival tone and the vibration. In the response to the call signal arrival, the response message is automatically sent on the basis of the response signal. Hence, the response to the call signal arrival can be done without any trouble to the adjacent strangers.

Also, according to the present invention, one response message arbitrarily selected by using the message selection switch is transmitted to the destination terminal. Thus, one response message can be selected from the plurality of response messages, depending on the situation of the user. Hence, the further appropriate response to the call signal arrival can be provided for the transmission source.

What is claimed is:

1. A portable radio communication apparatus, comprising:
a main body communicating with a partner; and
a sub-apparatus mechanically separated from said main body, wherein said main body and said sub-apparatus communicate with each other wirelessly, and said sub-apparatus includes a call signal arrival display unit and a response unit, and
wherein when said main body gets a call signal from said partner, said main body transmits a call arrival signal to said sub-apparatus, and said main body transmits a response message to said partner in response to a response signal, and
wherein said call signal arrival display unit sends a notice that said main body gets said call signal in response to said call arrival signal, and said response unit outputs said response signal to said main body in response to an operation performed on said response unit.

2. The portable radio communication apparatus according to claim 1, wherein said main body and said sub-apparatus communicate with each other wirelessly with the Bluetooth standard.

3. The portable radio communication apparatus according to claim 1, wherein said main body and said sub-apparatus communicate with each other wirelessly with the PIAFS (PHS Internet Access Forum Standard).

4. The portable radio communication apparatus according to claim 1, wherein said sub-apparatus is a tabletop unit.

5. The portable radio communication apparatus according to claim 1, wherein said sub-apparatus is a card-type unit.

6. The portable radio communication apparatus according to claim 1, wherein said sub-apparatus further includes a switch, and
wherein when said switch is one of on and off, said call signal arrival display unit sends said notice and said response unit outputs said response signal to said main body, and
wherein when said switch is the other of on and off, said call signal arrival display unit does not send said notice and said response unit does not output said response signal to said main body and said main body performs one of ringing and vibration when said main body gets said call signal from said partner.

7. The portable radio communication apparatus according to claim 1, wherein said main body transmits a preset response message to said partner as said response message.

8. The portable radio communication apparatus according to claim 1, wherein said sub-apparatus further includes a partner display unit displaying an identifier indicating said partner based on said call arrival signal.

9. The portable radio communication apparatus according to claim 1, wherein when said main body gets said call signal from said partner, both said main body and said sub-apparatus do not ring and do not vibrate.

10. The portable radio communication apparatus according to claim 1, wherein said call signal arrival display unit sends said notice by one of a light emission and a flashing indication without using a ringing and a vibration.

11. The portable radio communication apparatus according to claim 1, wherein said sub-apparatus further includes a response message display unit to display one of said response message and an identifier indicating said response message.

12. The portable radio communication apparatus according to claim 11, wherein said response message display unit displays one of a plurality of preliminarily prepared response messages selectively as said response message.

13. The portable radio communication apparatus according to claim 1, wherein said main body has a receiver unit and a transmitter unit and an operator used in a dial and a display unit displaying an information such as a dial and an antenna.

14. The portable radio communication apparatus according to claim 1, wherein said main body further includes a switch, and
wherein when said switch is one of on and off, said call signal arrival display unit sends said notice and said response unit outputs said response signal to said main body, and
wherein when said switch is the other of on and off, said call signal arrival display unit does not send said notice and said response unit does not output said response signal to said main body and said main body performs one of ringing and vibration when said main body gets said call signal from said partner.

15. The portable radio communication apparatus according to claim 1, wherein said operation is performed on said response unit by a user of said portable radio communication apparatus in response to said notice.

16. The portable radio communication apparatus according to claim 1, wherein said response message indicates that a user of said portable radio communication apparatus can not answer said call signal.

17. The portable radio communication apparatus according to claim 1, wherein said main body performs a disconnection process on said call signal after transmitting said response message.

18. The portable radio communication apparatus according to claim 1, wherein said response message is stored in said main body.

19. The portable radio communication apparatus according to claim 12, wherein said plurality of preliminarily prepared response messages indicate at least one of contents that a user of said portable radio communication apparatus is in a meeting, and that said user is in a car or train, and that said user will call said partner later.

20. The portable radio communication apparatus according to claim 12, wherein said one of said plurality of preliminarily prepared response messages is selected by a user of said portable radio communication apparatus.
